(19) United States
(12) Patent Application Publication
(10) Pub. No.: US 2003/0142832 A1
(43) Pub. Date: Jul. 31, 2003

(54) Adaptive method for detecting parameters of loudspeakers

(76) Inventors: Klaus Meerkoetter, Paderborn (DE); Joachim Wassmuth, Paderborn (DE)

Correspondence Address: KENYON & KENYON, ONE BROADWAY, NEW YORK, NY, 10004, US

(21) Appl. No.: 10/168,355

(22) PCT Filed: Dec. 18, 2000
(86) PCT No.: PCT/DE00/04511

(30) Foreign Application Priority Data
Dec. 17, 1999 (DE) 199 60 979.9

(51) Int. Cl. H04R 29/00; H04R 3/00

(52) U.S. Cl. 381/59; 381/96

(57) ABSTRACT

The method makes possible the determination of loudspeaker parameters in real operation through a measurement of the moving-coil current iₘ and it contains the following steps:

1) The measurement of the moving-coil current iₘ resulting from the excitation of the loudspeaker using a known input signal uₑ;

2) The simulated estimation of the moving-coil current for the same input signal using an equivalent electrical network and a time-discrete model that is derived therefrom by wave digital realization;

3) The change of the parameters in the loudspeaker model through a preceding determination of starting values and the minimization of the average squared error from the measured and simulated moving-coil current, using a gradient method.

The equivalent network contains a series circuit of two transformers, the first transformer on the secondary side having an inductor (Lₛ), and the second transformer on the secondary side having the parallel circuit of a resistor (1/r), a capacitor (M), and a third transformer.

### TECHNICAL AREA

The present invention relates to an adaptive method for determining loudspeaker parameters.

### BACKGROUND INFORMATION

In the development of electroacoustic transmission systems, it is important to be able both to recognize as well as to model the linear as well as the nonlinear transmission behavior of the electroacoustic transducer, i.e., of the loudspeaker. On the one hand, this modeling is necessary in order to be able in the design phase to check the influence of specific component parameters through simulations, and on the other hand, the transmission behavior of existing loudspeaker systems can subsequently be improved, for example, using a digital filtering or a predistortion of the drive signal both with respect to its linear as well as its nonlinear character. Here, time-discrete implementations of the model frequently function as state observers. Common to all applications is the requirement that the model imitate the real loudspeaker as closely as possible, which, after the model is defined, has the consequence that the parameters necessary for the model are to be achieved through measurements on a real loudspeaker.

For the modeling, equivalent electrical networks that approximate transducers are indicated in the literature, but they are not further exploited for determining parameters (H. Schurer: Linearization of Electroacoustic Transducers, Dissertation, Twente Enschede University, November 1997; W. Kippel, Dynamic Measurement and Interpretation of the Nonlinear Parameters of Electrodynamic Loudspeakers, Journal of the Audio Engineering Society, Vol. 38, No. 12, December 1990, pp. 944-955; W. Kippel: “The Nonlinear Transmission Behavior of Electroacoustic Transducers,” Dissertation, Technical University Dresden, 1994). Alternatively, general model formulations have been investigated, for example, in the form of Volterra Series Developments (Schurer, op cit; A. J. M. Kaizer: Modeling of the Nonlinear Response of an Electrodynamic Loudspeaker by a Volterra Series Expansion, Journal of the Audio Engineering Society, Vol. 35, No. 6, June 1987, p. 421-433), neural networks (Johan A. Suykens; Joos P. L. Vandewalle; Bart L. R. DeMoor: Artificial Neural Networks for Modeling and Control of Nonlinear Systems, Kluwer Academic, 1996) or NARMAX modeling (Han-Kee Jang; Kwang-Joon Kim: Identification of Loudspeaker Nonlinearities using the NARMAX Modeling Technique, Journal of the Audio Engineering Society, Vol. 42, No. 1/2, 1994, pp. 50-59), which nevertheless do not permit any physical interpretation and, under certain circumstances, require very many parameters. However, it is common to all the proposed methods that, on the mechanical, or acoustic, side, a signal would have to be measured, such as the diaphragm deflection or the sound pressure. In addition, most methods are conceived as offline methods, made up of measurement and subsequent evaluation. In this context, signals are often used as measuring signals, which do not always reflect the real operation of the loudspeaker, such as in (J. Scott, J. Kelly, G. Leembruggen: New Method of Characterizing Drive Linearity, Journal of the Audio Engineering Society, Vol. 44, No. 10, 1996, p. 864; D. Clark: Precision Measurement of Loudspeaker Parameters, Journal of the Audio Engineering Society, Vol. 45, No. 3, 1997, p. 129-141). Only one single known adaptive method (W. Kippel: Adaptive Nonlinear Control of Loudspeaker Systems, Journal of the Audio Engineering Society, Vol. 46, No. 11, November 1998, pp. 939-954) makes it possible to be able to identify the loudspeaker parameters in real time. However, due to parameter dispersions within one parameter series and due to parameter changes that unavoidably arise in real operation as a result of aging, temperature changes, and the installation of the loudspeaker, there exists a need for an adaptive method, so that every loudspeaker can be measured separately, i.e., the parameters that have already been determined can be corrected.

Presentation of the Invention, Objective, Solution, Advantages

The objective of the present invention was to make available an adaptive method for determining loudspeaker parameters, which would make it possible to measure each loudspeaker separately, i.e., which would make it possible to correct the already determined parameters, in order to be able to measure the effects that occur as a result of the aging, temperature changes, and/or installation of the loudspeaker. In this context, the method is conceived preferably so as not to require expensive mechanical measurements, such as diaphragm deflection or sound pressure, and so as not, as far as possible, to require artificial measuring conditions.

This objective is achieved by a method having the features of claim 1.

The adaptive method for determining the loudspeaker parameters thus contains the following steps:

a) measurement of the characteristic curves of input voltage uₑ and moving-coil current iₘ of the loudspeaker,

b) calculation of a simulated moving-coil current iₛ associated with measured input voltage uₑ using an electric network model having variable parameters α,

c) adaptation of variable parameters α of the network model for optimizing a cost function calculated from the model deviation

e=iₘ−iₛ.

In this context, the cost function calculated from model deviation e is an expedient choice so that its optimization results in minimizing the model deviation. In general, the cost function will be positively-defined (or negatively-defined), and accordingly the optimization will be made up of a minimization (or maximization). The method according to the present invention uses moving-coil current iₛ as the loudspeaker internal variable to be simulated. This variable is also easy to determine and to monitor during the actual operation of the loudspeaker. Expensive measurements of mechanical variables, such as the diaphragm deflection or the sound pressure, are not required. Therefore, the method has the advantage that during the ongoing operation of the loudspeaker it can be carried out in real time, and it is therefore possible to immediately recognize parameter changes in the loudspeaker system.

According to claim 2, an electrical network model, preferably employed in the above method, has the series connection of the following elements:

a) a resistor Rₑ,

b) a first transformer, which on the secondary side is terminated by an inductor Lₛ, and

c) a second transformer, which on the secondary side contains the parallel circuit of a resistor 1/r, a capacitor M, and a third transformer, the third transformer on the secondary side being closed off by an inductor Lₖ.

It has been shown that all the essential electrodynamic mechanical characteristics of a loudspeaker can be simulated using a model of this type, a physical interpretation, corresponding to the loudspeaker, being inferred from the parameters of the network.

According to claim 3, a time-discrete network model is preferably used, because models of this type make it possible to perform calculations on familiar data-processing devices (for example, microprocessors) with a high degree of flexibility. In this context, it is advantageous to use a time-discrete network model, which is obtained from a continuous network model, in the manner of a wave digital realization, for example, from a network model in accordance with claim 2.

The adaptation of the variable parameters of the network model is carried out according to claim 4 preferably using a gradient method. A method of this type can be carried out easily and using known methods, and it leads, with verifiable certainty, to locating a (local) optimum for the cost function.

In this context, according to claim 5, appropriate starting values for the parameters of the network model are determined, preferably by a pre-measurement of the loudspeaker. The start of the network model using parameters that are as close as possible to the real parameters of the loudspeaker is especially useful in the kind of optimization methods which, without further measures, can only locate the local optimum closest to the starting value. The latter is the case, for example, for the gradient method according to claim 4. In this context, the aforementioned pre-measurement of the loudspeaker is a procedure to be carried out once for initializing the network model, so that the network model during subsequent operation does not require any further cumbersome mechanical measurements.

The cost function, according to claim 6, can be calculated from the squared model deviation

e²=(iₘ−iₛ)²,

these variables preferably being subjected to a temporal averaging or a deep-pass filtering (which creates an effect comparable to averaging). Temporal averagings have the advantage that point-type outliers of the model deviation can be compensated for, and the adaptation method is thus stabilized.

### BRIEF DESCRIPTION OF THE DRAWINGS

In what follows, the method according to the present invention is described in detail on the basis of an example, in accordance with the Figures. The following are the contents:

FIG. 1 the adaptation principle;

FIG. 2 the schematic design of the loudspeaker;

FIG. 3 a coupling network;

FIG. 4 the design of the coupling network in greater detail;

FIG. 5 a network for simulating the stiffness;

FIG. 6 the equivalent network;

FIG. 7 the simulation of a transformer using power waves;

FIG. 8 the signal flow graph of a power-wave adapter;

FIG. 9 the wave digital model of the loudspeaker;

FIG. 10 the schematic impedance of a loudspeaker;

FIG. 11 the impedance curve in accordance with quantity and phase;

FIG. 12 the measurement design for pre-measuring the loudspeaker;

FIG. 13 the amount of the measured impedance;

FIG. 14 the amount of the calculated impedance;

FIG. 15 the curve of the stiffness;

FIG. 16 the curve of the force factor;

FIG. 17 the curve of the moving-coil inductance;

FIG. 18 the determination of the error signal;

FIG. 19 the deep-pass filter for averaging;

FIG. 20 determination of the gradient signal;

FIG. 21 the curve of the average squared error;

FIG. 22 the measured and the simulated moving-coil current;

FIG. 23 the measured (dark) and simulated (bright) moving-coil current;

FIG. 24 the measured (dark) and simulated (bright) deflection;

FIG. 25 the measured (dark) and the simulated (bright) deflection.

### THE BEST WAY TO CARRY OUT THE INVENTION

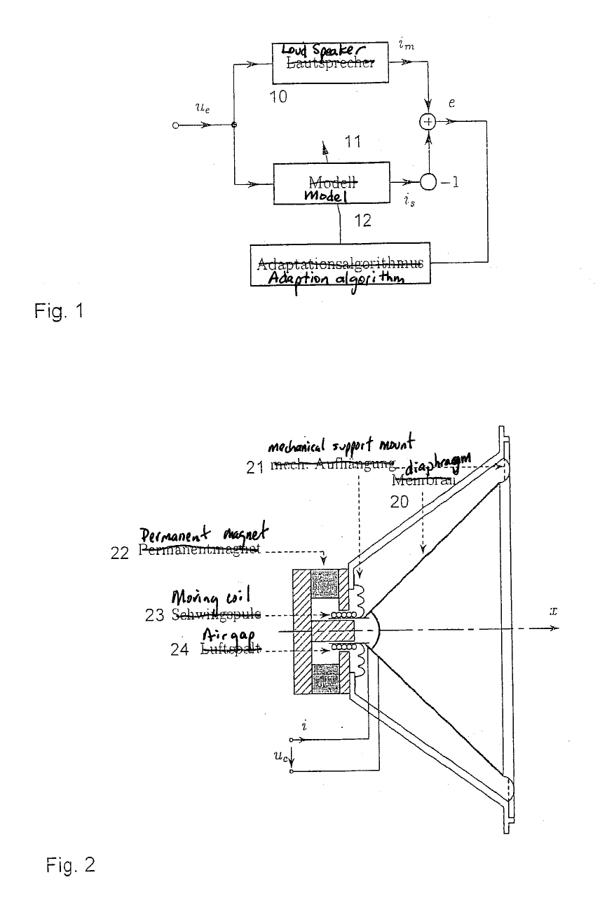

Reference was already made above to the fundamental necessity of understanding and modeling the transmission behavior of loudspeakers. Due to the parameter spread within one production series and due to the parameter changes that unavoidably occur in actual operation due to aging, temperature changes, and the installation of the loudspeaker, there is, in this context, a special need for an adaptive method, so that every loudspeaker can be measured separately, or the already determined parameters can be corrected. In this context, for the purpose of generating an error signal, it is not recommended to use an expensive deflection or sound-pressure measurement, but rather a simple measurement of the moving-coil current which arises in the case of the signals that approximate actual operation (colored noise) or that even represent actual useful signals. Using the method that is put forward here, it is possible, simply by measuring the moving-coil current, to determine the parameters of loudspeaker 10 (FIG. 1), in that during operation an error signal e, via an adaptation algorithm 12, is exploited for changing the parameters of a loudspeaker model 11 that is running in parallel. In this context, the adaptation algorithm assures the minimization of a cost function still to be defined of the error signal from measured and simulated moving-coil current

e=iₘ−iₛ.

An essential component of the method is the model used. Here, a transducer-like description was worked out in the form of an equivalent electrical network, making possible a direct physical interpretation of the parameters and signals that arise. Due to the nonlinearity of the system, in this context, both deflection as well as current-dependent components occur. In this context, the created network satisfies the requirement for passivity, i.e., that the total amount of energy converted or stored in the system may not be greater than the energy supplied from outside, a characteristic which the real loudspeaker obviously also satisfies. This passivity is forcibly created as a result of the fact that, in the model, only components are used that are concretely passive.

Using a description of the network via so-called power waves, it is possible to indicate a time-discrete simulation of the same, a so-called wave digital realization, which in comparison to other modelings has several positive features. For one, this wave digital description maintains the passivity of the network, so that the stability of the time-discrete realization can be assured even taking into account word-length limits as well as rounding and overflow operations, such as are unavoidable in digital systems. By using power waves as signal variables, stability is not endangered even if, as in the previous case, the component parameters change due to deflection and current dependencies. Precisely this characteristic makes the wave digital realization of interest also for an adaptation. A further advantage of the wave digital realization is the retention of the transducer-like description, so that here too an interpretation of parameters and signals is also possible. Also noteworthy is the efficiency of the realization, because the number of time-delay elements is essentially determined by the order of the systems to be modeled, i.e., by the number of state storage units, which is not the case, for example, in Volterra series development or neural networks, and these modelings are therefore excluded for real-time applications. The further important component of the method described is the adaptation algorithm used here. To achieve the most rapid possible convergence, a gradient method is used. Due to the nonlinearity of the system, in this context, locating a global minimum of the cost function, of course, cannot be guaranteed. By seeking useful starting values for the adaptation, however, it is possible to circumvent this problem. I.e., using a pre-measurement of the loudspeaker through an online method, the starting values are first determined, the measurement of one sample from a series having been proven to be sufficient. The final calibration to the actual loudspeaker in the form of the described moving-coil measurement and the simultaneous adaptation of the parameters yields then in real-time an estimation of the loudspeaker parameters, which takes into account, on the one hand, the manufacturing-technical divergence within a series and, on the other hand, the parameter changes caused by operation. The essential components of the method

electrical network model

time-discrete model

starting value determination

adaptation algorithm

are discussed in detail below.

Modeling the Performance of Loudspeakers in the Deep-Tone Range

The described method has heretofore been applied to loudspeakers that operate in accordance with the electrodynamic principle. Loudspeakers of this type (FIG. 2) are essentially composed of a mechanically suspended diaphragm 20, which, in addition to having a slight mass, has a high inner stiffness. Via this diaphragm, mechanical vibrations (in the sense of an ideal piston radiator) are transmitted to the surrounding air. Suspension mount 21, which basically determines the mechanical friction and the stiffness of the loudspeaker, is formed by the reinforcement pleat that is visible from the outside and by the more inwardly situated centering, which is joined in each case to the loudspeaker holder, which is as stable as possible.

Rigidly coupled to the diaphragm is a cylindrical non-magnetic moving-coil support, onto which a copper wire is wound, potentially in many layers, thus forming moving coil 23. This moving coil is situated in air gap 24 of a permanent magnet 22. As a result of the geometry of the arrangement, a radially oriented magnetic field arises in the air gap, so that the field lines (in the homogeneous part of the magnetic field) are perpendicular to the windings of the moving coil. As a result of an electrical voltage uₑ applied to the terminal clamps, there is derived, as a result of the ensuing current flow through the coil, a Lorentz force, which drives the diaphragm in the axial direction, so that a deflection x arises. As is clear from FIG. 2, a deflection from the resting position away from the permanent magnet is registered as positive. This diaphragm motion is transmitted to the surrounding air, it being possible to describe the transmission behavior using an acoustic impedance. Because here only the electrical and mechanical performance is to be investigated in greater detail, the coupling to the acoustic space is not discussed here.

To derive an equivalent network model, which makes possible a description of the performance of a loudspeaker of this type in the deep-tone range, first an energy investigation of the entire system is carried out. It follows from this energy level, that the change in mechanical energy W_{mech} stored in the system and magnetic energy W_{magn} are equal to the electrical power supplied from the outside via the terminal clamps, if, in addition, the ohmic losses on electrical side and the friction losses are mechanical side are taken into account:

(1)

In this context, Rₑ is the direct current resistance of the moving coil, which is influenced mechanically by frictional force Fᵣ=r& at a velocity v=x&.

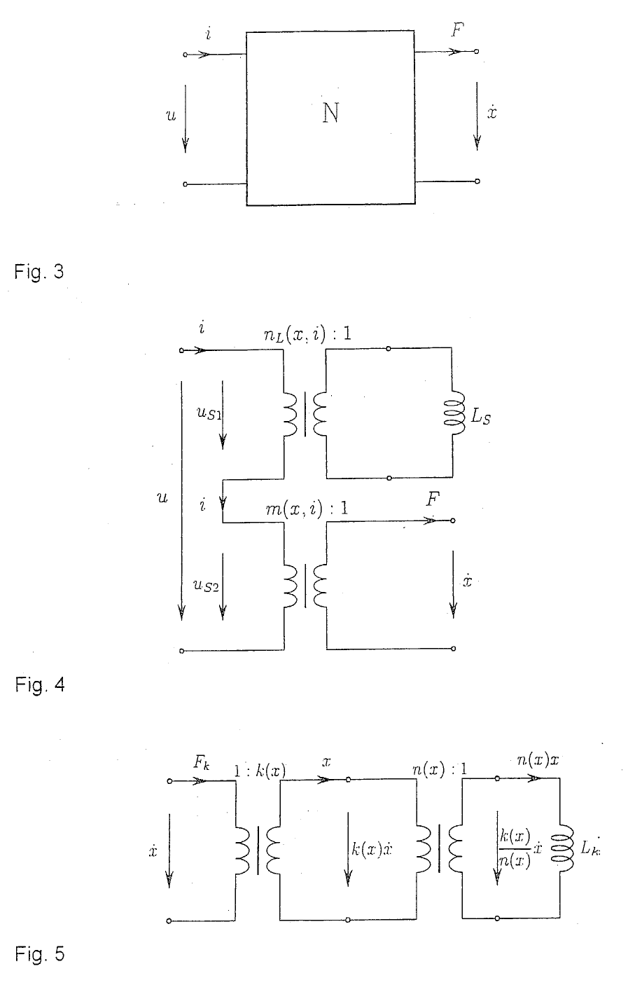

To establish a connection between the electrical variables, voltage u and current I, and the mechanical variables, velocity x& and the force exerted on diaphragm F, it is necessary to look for a suitable coupling network N (FIG. 3), which, on the one hand, contains an element for storing the magnetic energy of the moving coil. Thus the requirement for the energy level is satisfied by the equation

dW_{magn}=uidt=Fdx. (2)

The stored energy is described by

$${W}_{magn} ( x , i ) = \frac{1}{2} L ( x , i ) {i}^{2} where L ( x , i ) > 0 \qquad ( 3 )$$

and therefore assures that this is a positively semi-defined form of the current and of the location on account of

W_{magn}(x,0)=0 and W_{magn}(x,i)>0∀i≠0. (4)

The variable occurring in this context L(x;i), based on its definition, is designated as a result of the energy as well as the energetic inductance. The location-dependence of this variable is therefore based on the fact that when the coil moves, only one part of it is always located in the pole shoe, as a result of which, seen from a different point of view, a cylindrical (iron) body is moved into the coil, and is once again moved out of it. As a result of the current dependency, it is possible, if appropriate, to take into account the magnetizing effects that arise.

From the energy described by equation (3), the result is

$${dW}_{magn} ( x , i ) - \frac{\partial {W}_{magn}}{\partial x} dx + \frac{\partial {W}_{magn}}{\partial i} di - \frac{1}{2} {i}^{2} \frac{\partial L}{\partial x} dx + \vert iL + \frac{1}{2} {i}^{2} \frac{\partial L}{\partial i} \} di . \qquad ( 5 )$$

On the other hand, care must be taken in the coupling network for maintaining the law of induction, because a voltage is induced by the motion of a conductor in the magnetic field. In this context, first of all, the entire magnetic flux φ(x;i) permeating the moving coil is admitted as both location as well as current-dependent. Therefore, the law of induction can be formulated by the equation

$$u = \frac{ⅆ φ ( x , i )}{ⅆ t} - \frac{\partial φ}{\partial x} \frac{ⅆ x}{ⅆ t} + \frac{\partial φ}{\partial i} \frac{ⅆ i}{ⅆ t} . \qquad ( 6 )$$

If the induction voltage (6) in equation (2) is adjusted, then the result is

$${dW}_{magn} ( x , i ) = [ i \frac{\partial φ}{\partial x} - F ] dx \vert i \frac{\partial φ}{\partial i} di \qquad ( 7 )$$

By comparing (5) and (7), the result is

$$F = i \frac{\partial φ}{\partial x} - \frac{1}{2} {i}^{2} \frac{\partial L}{\partial x} = m ( x , i ) i \qquad ( 8 )$$

where

$$m ( x , i ) = \frac{\partial φ}{\partial x} - \frac{1}{2} i \frac{\partial L}{\partial x} , \qquad ( 9 )$$

which can describe the transmission of the current to the force. However, the comparison also yields

$$\frac{\partial φ}{\partial i} = L + \frac{1}{2} i \frac{\partial L}{\partial i} \qquad ( 10 )$$

as the relation between flux and energy inductance. If both equations (9) (solved using ∂Φ/∂i) and (10) are inserted into equation (6), then the voltage results as

$$u - [ m ( x , i ) + \frac{1}{2} i \frac{\partial L}{\partial x} ] \frac{ⅆ x}{ⅆ t} + [ L + \frac{1}{2} i \frac{\partial L}{\partial i} ] \frac{ⅆ i}{ⅆ t} , \qquad ( 11 )$$

which can also be described as

$$u - m ( x , i ) \frac{ⅆ x}{ⅆ t} + \sqrt{L} \frac{ⅆ \sqrt{Li}}{ⅆ t} - {u}_{S1} + {u}_{S2} \qquad ( 12 )$$

where

$${u}_{S1} = {n}_{L} ( x , i ) {L}_{S} \frac{ⅆ {n}_{L} ( x , i ) i}{ⅆ t} \qquad ( 13 )$$

$${u}_{S2} = ni ( x , i ) \frac{ⅆ x}{ⅆ t} \qquad ( 14 )$$

$${n}_{L} ( x , i ) = \sqrt{\frac{L ( x , i )}{{L}_{S}}} and {L}_{S} > 0. \qquad ( 15 )$$

The resulting equation (12) can now be interpreted as a series connection of two transformers, as is depicted in FIG. 4. Whereas the first transformer having transmission ratio n_{L}(x;i): 1 is terminated on the secondary side by a linear inductor Lₛ, and therefore functions to store energy W_{magn}, the other transformer having transmission ratio m(x;i): 1 describes the force coupling of equation (8).

The above relationships can be represented in even greater detail, if magnetic flux Φ(x;i) is subdivided into

φ(x,i)=φ_{P}(x)+φ_{S}(x,i), (16)

Φ_{P}(x) corresponding to the component portion derived by the permanent magnet. Superimposed on this in an additive manner is a location- and current-dependent component portion Φ_{S}(x;i), which is derived from the moving coil through which current is flowing. On the basis of equation (10), it then follows

$$\frac{\partial {φ}_{S} ( x , i )}{\partial i} = L + \frac{1}{2} i \frac{\partial L}{\partial i} , \qquad ( 17 )$$

so that it can be indicated as the relation between flux Φ_{S}(x;i) and inductance L(x;i)

$${φ}_{S} ( x , i ) = \frac{1}{2} L ( x , i ) i + \frac{1}{2} {\int }_{0}^{i} L ( x , i ) ⅆ i , \qquad ( 18 )$$

if Φ_{S}(x;0)=0 is assumed, i.e., only a current flow through the moving coil generates additional flux Φ_{S}. Then the following applies for the transmission of the current to the force

$$m ( x , i ) = \frac{ⅆ {φ}_{P}}{ⅆ x} + \frac{1}{2} \frac{\partial }{\partial x} {\int }_{0}^{i} L ( x , i ) ⅆ i , \qquad ( 19 )$$

it being possible to interpret the variables arising here in a direct and clear manner. The first term for describing the influence of the permanent magnet is termed in the literature the force factor. It is the product of magnetic induction B and effective conductor length 1, which is abbreviated as Bl(x). Because transmission factor m(x;i) must be multiplied by current i to obtain the force on the mechanical side, product Bl(x)i can be identified as the resulting Lorentz force. The second component portion of the force

$${F}_{r} ( x , i ) = \frac{1}{2} i \frac{\partial }{\partial x} {\int }_{0}^{i} L ( x , t ) ⅆ i \qquad ( 20 )$$

is termed the reluctance force and can be clearly interpreted as the force resulting from the change in the magnetic energy. If the special case is also considered that the flux derived by the moving coil is also only a function of location and no longer of current, then the reluctance force is simplified to

$${F}_{r} ( x , i ) = \frac{1}{2} {i}^{2} \frac{ⅆ L ( x )}{ⅆ x} . \qquad ( 21 )$$

Heretofore, this reluctance force has been discussed in the literature as inserting a controlled current source on the mechanical side.

Herewith the description of the coupling between the electrical and mechanical sides is complete.

If the discussion hereafter is limited to the mechanical side, then, in a consideration of energy, both the kinetic energy stored in vibrating mass M (diaphragm, moving coil, moving-coil support, parts of the suspension support, etc.) as well as the deformation energy resulting from the stiffness of the suspension support (centering, pleated fold) should be taken into account

$${W}_{mech} = \frac{1}{2} M {v}^{2} + {\int }_{0}^{x} {F}_{k} ( ξ ) ⅆ ξ . \qquad ( 22 )$$

However, for a large working range, no linear force-path law can be indicated for describing the return force, so that the latter should be taken into account in the form of

Fₖ(x)=k(x)x (23)

In order to be able to simulate the mechanical side using a network, it is also necessary here once again to look for passive partial networks. For this purpose, reference is made to the IN gate from FIG. 5, at whose input diaphragm velocity x& (as voltage) and return force Fₖ (as current) are applied. Via the first transformer having transmission ratio l:k(x), the secondary-side current is identical to deflection x. Just as in the case of the inductor, the stored energy here can also be represented in the form

$${W}_{k} = {\int }_{0}^{x} {F}_{k} ( ξ ) ⅆ ξ = \frac{1}{2} {n}^{2} ( x ) {x}^{2} {L}_{k} \\ where {L}_{k} > 0 and n ( x ) > 0 ∀ x \neq 0 , \qquad ( 24 )$$

which is assured as a result of the second transformer having the transmission ratio

$$n ( x ) = \sqrt{\frac{{\int }_{0}^{x} k ( ξ ) ξ ⅆ ξ}{\frac{1}{2} {x}^{2} {L}_{k}}} \qquad ( 25 )$$

and having linear inductor Lₖ that is connected on the secondary side to this second transformer. Both transformers, of course, can be combined into one having the transmission ratio

$${n}_{k} ( x ) = \frac{n ( x )}{k ( x )} - \frac{1}{k ( x )} \sqrt{\frac{{\int }_{0}^{x} k ( ξ ) ξ ⅆ ξ}{\frac{1}{2} {x}^{2} {L}_{k}}} . \qquad ( 26 )$$

The transmission model that is obtained in this manner describes the correct relationship between force Fₖ and the stored deformation energy. Here as well, in the literature, reference is often made only to an inductor that is a function of the deflection. As a result of the choice of gate variables, the storage of the kinetic energy can then be brought about by a capacitance of the magnitude M, on which the force has an effect

(27)

If the friction losses resulting from a frictional force are now taken into account

Fᵣ=rx, (28)

which can be simulated by a resistor of the size 1/r, then for simulating the mechanical side, the result is the parallel connection of these three elements, because coupled force F must be equal to the sum of these three mechanical partial forces

F=Fₖ(x)+F_{M}+Fᵣ. (29)

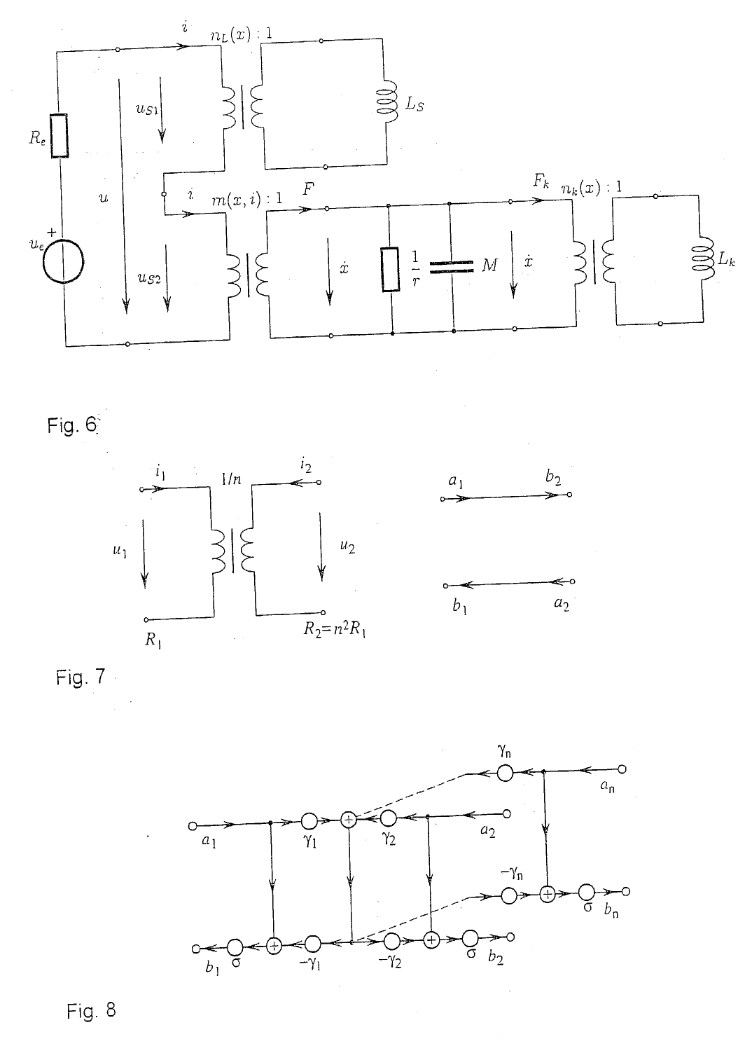

Overall, the result is an equivalent network for describing the behavior of nonlinear deep-tone loudspeakers, as is indicated in FIG. 6. In this context, on the input side, signal uₑ is coupled via an ideal voltage source. Moreover, the ohmic losses are taken into account by direct current resistor Rₑ of the moving coil.

Based on the above observations, it is now possible to construct a system of coupled differential equations, by calculating the voltage total on the electrical side and the force (current) total on mechanical side, so that the result along with equations (12), or (13+14), (29), and (8) altogether is

$$\begin{matrix}{u}_{e} - {R}_{e} i + \frac{ⅆ L ( x ) i}{ⅆ t} + Bl ( x ) \frac{ⅆ x}{ⅆ t} & ( 30 ) \\ Bl ( x ) i + \frac{1}{2} {i}^{2} \frac{ⅆ L ( x )}{ⅆ x} = M \frac{{ⅆ}^{2} x}{ⅆ {t}^{2}} + r \frac{ⅆ x}{ⅆ t} + k ( x ) x . & ( 31 )\end{matrix}$$

In contrast to the models known heretofore, the network model derived here possesses the essential advantage that it is made up of concretely passive elements, i.e., every single component performs in a passive manner. Therefore, the positivity of the component values assures the passivity of the overall network. In the network models known heretofore, passivity cannot be guaranteed, because controlled sources had to be inserted for describing effects that are taken account of here.

Time-Discrete Modeling

Power Waves

Power waves are the designation for the connections between voltage u and current i at one gate having positive gate resistance R in the form

$$\begin{matrix}a = \frac{u + Ri}{2 \sqrt{R}} & ( 32 ) \\ b = \frac{u - Ri}{2 \sqrt{R}} , & ( 33 )\end{matrix}$$

a, as usual, designating the incident wave, and b designating the reflected wave. The simulation of the components, capacitor and inductor, does not change as a result, in comparison to the use of voltage waves (Fettweis, A.: Wave Digital Filters: Theory and Practice, Proceedings of the IEEE, Vol. 74, No. 2, February 1986, pp. 270-327). The realization of a resistive voltage source differs from the standard realization only by a scaling of the input voltage as incident wave having the factor ½ √R. A transformer having transmission ratio 1/n can be depicted using power waves by a simple connection, if for the two gate resistors the equation R₂=n²R₁ applies, see FIG. 7.

The simulation of the connection network now takes place using adapters. Dispersion matrix S_{S} of a n-gate series circuit can be described in the form

S_{S}=1−γγ^{T}, (34)

if 1 designates the unity matrix and γ designates the vector of the adapter coefficients, whose elements γᵢ can be calculated from gate resistances Rᵢ via

$${γ}_{i} = \sqrt{\frac{2 {R}_{i}}{{\sum }_{v - 1}^{n} {R}_{p}}} . \qquad ( 35 )$$

For an n-gate parallel adapter, the result is the dispersion matrix

S_{P}=−1+γγ^{T}, (36)

the adapter coefficients being derived by gate conductances Gᵢ yielding

$${γ}_{i} = \sqrt{\frac{2 {G}_{i}}{{\sum }_{v = 1}^{n} {G}_{v}}} . \qquad ( 37 )$$

The passivity for both adapters can be assured if for the adapter coefficients the following applies in each case

$${γ}^{T} γ \leq 2 ⟺ {\sum }_{i}^{n} {γ}_{i}^{2} \leq 2 . \qquad ( 38 )$$

On the basis of the dispersion matrix, it is also becomes clear how a reflection-free gate can be achieved. Thus if, in a series (parallel) adapter for the corresponding gate the gate resistance (conductance) is selected so as to be equal to the total of the other gate resistances (conductances), then the adapter coefficient takes on the value 1, and the reflected wave is independent of the wave incident at the same gate. The realization of the dispersion matrix of a series or parallel adapter is depicted in FIG. 8 in the form of a signal flow graph, σ=1 being selected for the series adapter, and σ=−1 being selected for the parallel adapter.

Wave Digital Realization of the Loudspeaker Model

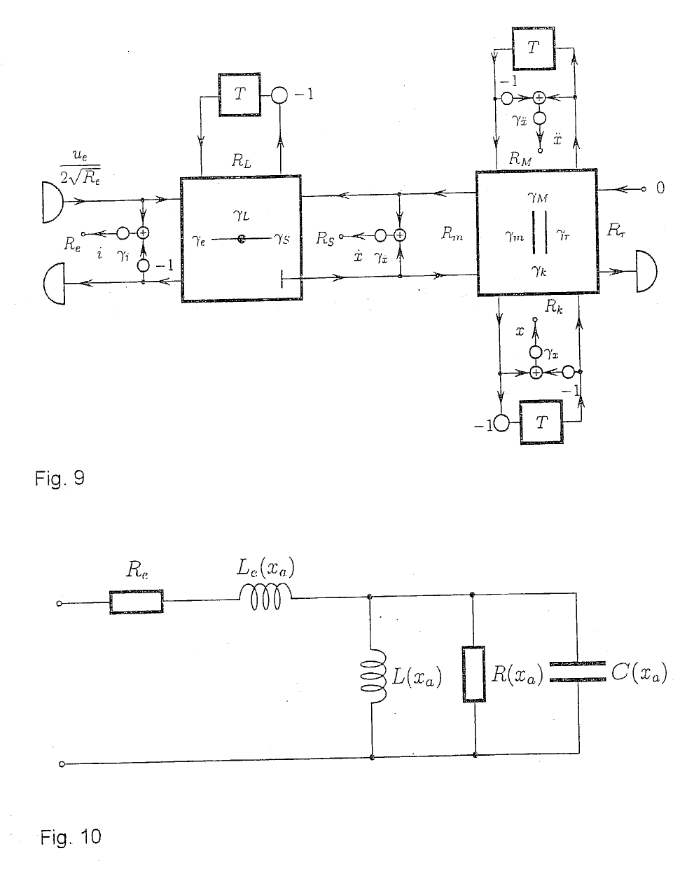

The digital model of the loudspeaker that comes about in the use of power waves is now discussed, as it is depicted in FIG. 9.

It contains two adapters, of which the first one represents the series connection of the electrical input side, whereas the second one simulates the parallel connection on the mechanical side, so that at the appropriate gates the simulation of the stiffness can be found in the form of an inductor, the mass in the form of a capacitor, and the friction using a resistor. As a result of the specific choice of the gate resistances, no transformer requires separate realization. Specifically, the gate resistances should then be selected as follows. For the moving coil inductance, it is

$${R}_{L} = {n}_{L}^{2} ( x ) \frac{2 {L}_{S}}{{T}_{a}} = \frac{2 L ( x )}{{T}_{a}} , \qquad ( 39 )$$

Tₐ designating, as usual, the operating periods. Through the choice of

R_{S}=R_{C}|R_{L},

the reflection-free gate that is necessary for connecting to the parallel adapter is obtained. The transformer for the force coupling is taken into account by the gate resistance

$${R}_{m} = \frac{{R}_{S}}{{m}^{2} ( x , i )}$$

and the remaining gate resistances are selected at

$${R}_{M} = \frac{{T}_{a}}{2 M} {R}_{r} - \frac{1}{r} and {R}_{k} = {n}_{k}^{2} \frac{2 {L}_{k}}{{T}_{a}} . \qquad ( 41 )$$

Using equations (35) and (37), it is then possible to determine the necessary adapter coefficients. Using equations (32), it is possible at every gate to retrieve the voltage and current in accordance with

u=(a+b)\sqrt{R} (42)

$$i = \frac{a - b}{\sqrt{R}} . \qquad ( 43 )$$

To be able to determine the deflection- and current-dependent transmission ratios of the nonlinear transformers, the opportunity is exploited, and deflection x and moving-coil current I, but also diaphragm speed x& as well as diaphragm acceleration &&, are calculated for the signal flow, so that all signals of interest can be simulated. The coefficients necessary for this purpose are

$$\begin{matrix}{γ}_{i} = \frac{1}{\sqrt{{R}_{e}}} {γ}_{x} = \frac{1}{\overline{k} \sqrt{{R}_{k}}} , & ( 44 ) \\ {γ}_{x} = - \sqrt{\overline{R} m} {γ}_{x} = - \frac{1}{M \sqrt{{R}_{M}}} , & ( 45 )\end{matrix}$$

the minus sign being derived from the voltage orientation on the series adapter. In this context, the variables provided with a bar are to be understood as standardized and therefore dimensionless, i.e., all resistances are accounted for using \overline{R}ᵢ=Rᵢ/1 Ω, for the mass \overline{M}=M/1 kg applies, and for the stiffness \overline{k}=k/1(Nm) applies. However, the signals can only be calculated if the total signal flow has already been processed. To be able to determine the transmission ratios at the beginning of a time cycle, the values calculated in the pre-cycle are used, and therefore, of course, an error is permitted. In the case of sufficiently high operating rates, however, this approximation can be completely justified.

Determining Parameters

To be able to simulate the actual performance of the loudspeaker, a method is proposed which makes it possible to determine the parameters that are necessary for the model. In this context, a two-stage parameter estimation method arises, in which, in the first stage, starting values are first determined for the adaptive method that follows in the second stage. This determination of the starting values is discussed here by way of example on the basis of a small loudspeaker. As the result of measurements, it was able to be established that, when six identical loudspeakers are measured, the starting values are so widely dispersed that it becomes necessary to have a method which would permit each loudspeaker to be measured separately. This adaptive method is presented in the second section.

Starting Value Determination: Linearization in the Operating Point

For the purpose of determining the starting values, it is first necessary to present a means which uses as its point of departure the equivalent network model. If, under the assumption of a constant deflection xₐ, the mechanical components are brought into a force coupling onto the electrical side of the transformer, then a schematic representation of the loudspeaker impedance (FIG. 10) is achieved. It should once again be mentioned that this network only possesses validity in one operating point if the signal-caused changes of the deflection around this operating point xₐ are so slight that the deflection-dependent components can be viewed as constant. In this context, the following applies for the component variables that arise

$$L ( {x}_{a} ) = \frac{{Bl}^{2} ( {x}_{a} )}{k ( {x}_{a} )} , R ( {x}_{a} ) = \frac{{Bl}^{2} ( {x}_{a} )}{r} and C ( {x}_{a} ) = \frac{M}{{Bl}^{2} ( {x}_{a} )} , \qquad ( 46 )$$

so that for a fixed deflection xₐ, the impedance of this network can be calculated in a purely formal manner as

$$\begin{matrix}Z ( p , {x}_{a} ) = {R}_{e} + {pL}_{e} ( {x}_{a} ) + R ( {x}_{a} ) \vert \vert pL ( {x}_{a} ) \vert \vert \frac{1}{pC ( {x}_{a} )} \\ = {R}_{e} + {pL}_{e} ( {x}_{a} ) + \frac{pL ( {x}_{a} ) R ( {x}_{a} )}{R ( {x}_{a} ) + pL ( {x}_{a} ) + {p}^{2} R ( {x}_{a} ) L ( {x}_{a} ) C ( {x}_{a} )} , \\ = {R}_{e} + {pL}_{e} ( {x}_{a} ) + \frac{{pBl}^{2} ( {x}_{a} )}{k ( {x}_{a} ) + pr + {p}^{2} M}\end{matrix} \qquad ( 47 )$$

if Rₑ is the direct-current resistor and Lₑ(xₐ) is the inductor of the moving coil, Bl(xₐ) is the force factor, M is the oscillating mass, k(xₐ) is the stiffness, and r is the friction of the mechanical supporting mount.

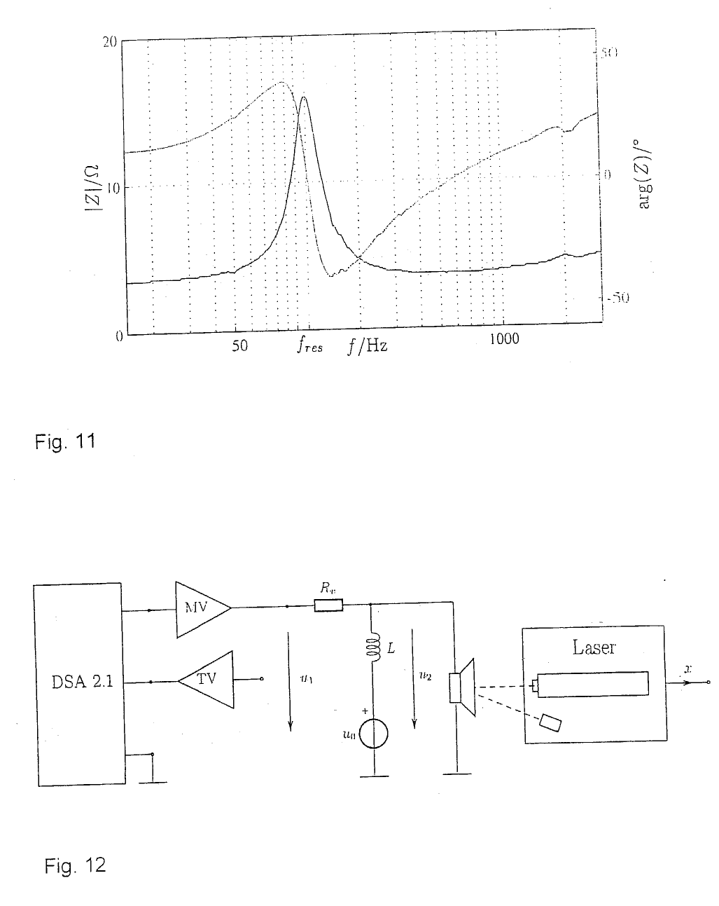

Therefore, the loudspeaker is approximated in every operating point by its linear model. FIG. 11 depicts a typical curve of the impedance of the loudspeaker described here, separated according to amount and phase. Clearly recognizable is the resonance position at fᵣₑₛ=\sqrt{k/M}/(2π), this frequency range also being used for determining the Thiele-Small parameters (R. H. Small: Closed-Box Loudspeaker Systems, Part I: Analysis, Journal of the Audio Engineering Society, Vol. 20, December 1972, pp. 798-808), because here the essential parameters of a damped, 2nd-order mechanical vibrating system, as is the case in the loudspeaker, are reflected in the curve of the impedance. The rising slope of the amount of the impedance is a function of the inductance of the moving coil at high frequencies.

As a result of the supplemental power supply of a direct current, a constant deflection xₐ is now derived in the loudspeaker, and therefore an operating point is set. In FIG. 12, the principal measuring design can be seen, in which this constant pre-deflection can be set via the direct-voltage source. Inductor L functions to separate the measuring signal from the voltage source. For this purpose, its value must be as large as possible, which is assured by using a role of wound, lacquered copper wire of a sufficient diameter. Its influence could be calculated afterwards by a separate measurement. Using a laser measuring device operating on the basis of the triangulation method, deflection x, i.e., the location of the diaphragm, is measured without contact, so that the vibrating behavior is not impacted as a result. The impedance measurements in each operating point have been carried out using digital system analyzer DSA 2.1, the moving-coil current derived by the measuring signal having been so limited by the use of a measuring amplifier MV and by the selection of a pre-resistance of Rᵥ=1 kΩ that a compromise between a minimal deflection around the operating point and precision of resolution of the measuring system was able to be achieved. The additional deflection caused by the measuring signal during the impedance measurement could then no longer be established using the laser measuring device. Therefore, the requirement of the measuring method, that the parameters as a result of the measurement in one operating point no longer change under the influence of the measuring signal, is fulfilled. The reference measurement of voltage u₁ and the actual measurement of voltage u₂ were supplied to measuring system DSA 2.1 via an isolation amplifier TV for coupling out of the DC component, the measuring system having calculated the impedance curve in the knowledge of pre-resistance Rᵥ. As the operating point, a positive and negative deflection were selected in alternating fashion in order to avoid hysterese effects. In setting the operating point, it was possible using the laser measuring device to detect a creeping effect, not visible to the naked eye, which was evident in the fact that the deflection of the diaphragm at first abruptly rises, but the resulting position of rest is then achieved at a time constant of several seconds. These supposedly viscoelastic effects of the diaphragm suspension have not heretofore been a component part of the modeling and therefore are not further described. These effects certainly complicate and prolong the measuring sequence. In this measuring method, the problem lies in deflections ≧±2 mm, because for this purpose high moving-coil currents are necessary, which could influence the moving coil system (heating, magnetization effects).

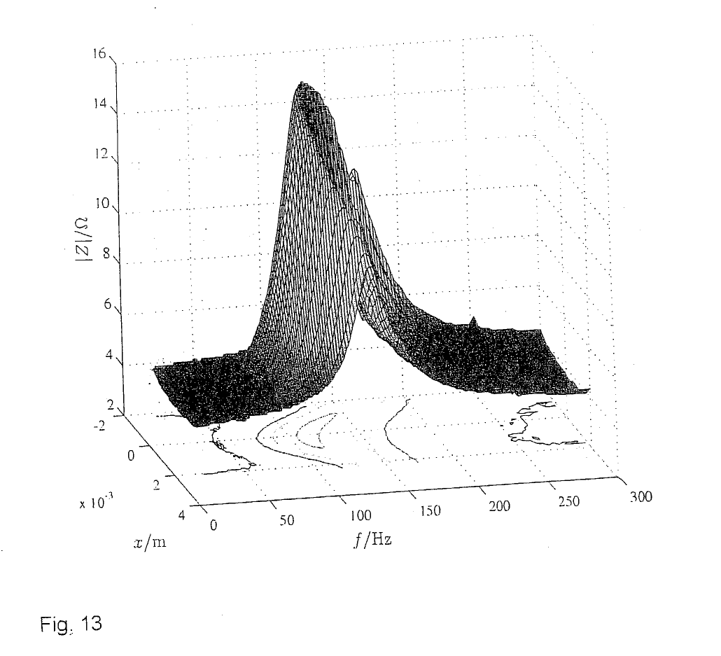

If the impedance curves measured for different deflections are plotted, in accordance with the amount, over the location and frequency, then the result is a representation according to FIG. 13. Below, in the x-f plane, the contour lines can be seen. Positive deflections here signify a motion “to the outside,” i.e., away from the permanent magnet. Clearly visible is the change in the resonance range, which relates to both the frequency position (see the contour representation) as well as the magnitude of the resonance maximum. In particular, it is striking here that there is no symmetry in the area around the position at rest. This asymmetry could also be established during the measurements, because for negative deflections, a higher constant current was necessary than for achieving the same positive deflection. The interruptions at 250 Hz are attributable to network disruptions. For the measured loudspeaker, first a Thiele-Small parameter measurement was carried out using the DSA 2.1 at the smallest possible modulation amplitude, to obtain estimated values for the linear parameters. In particular, an impedance measurement using a supplemental mass on the diaphragm due to the resulting resonance shift, supplies an estimated value for vibrating mass M. Similarly, friction r and moving-coil resistance Rₑ were separately determined, so that the values resulted

(48)

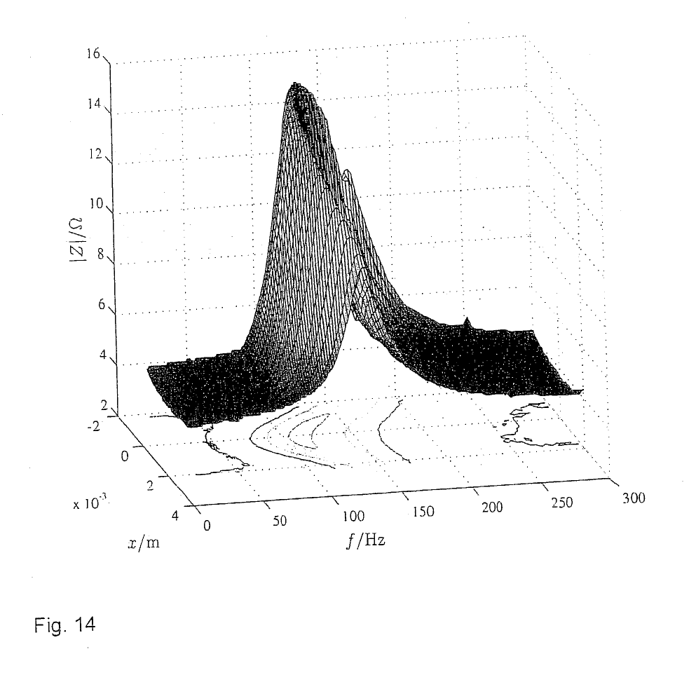

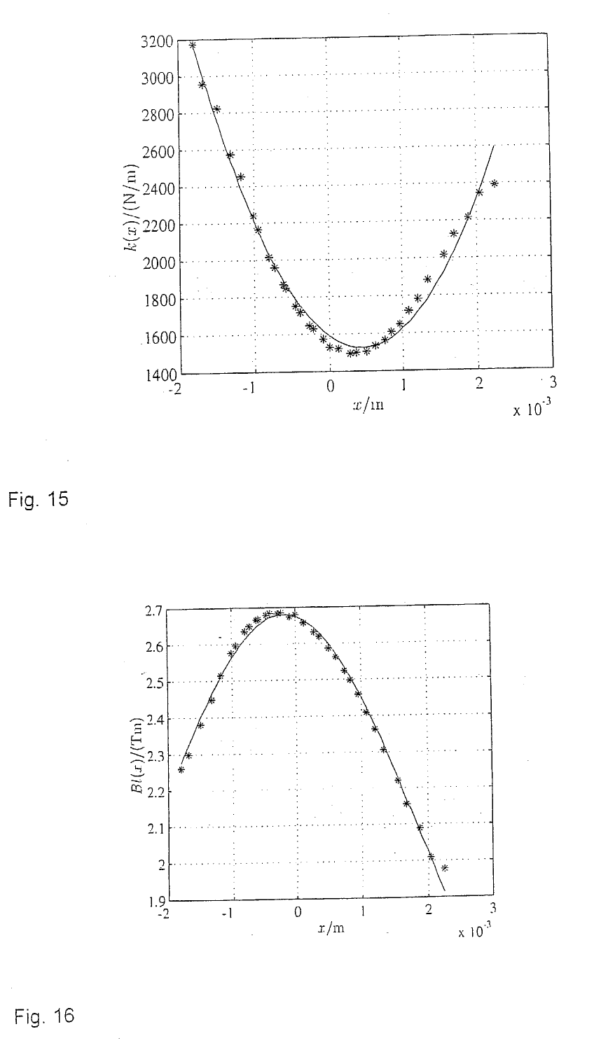

Then, three parameters, stiffness k, force factor Bl, and moving-coil inductance Lₑ, are to be determined for each deflection. For this purpose, impedance function (47) under MATLAB™ is bound into an optimization routine, which in each case determines these three parameters by minimizing a function of the error between the measured and the calculated amount of the impedance for each deflection. As a control, the impedance was again calculated using the estimated parameters for every deflection for the loudspeaker, whose measured impedance in FIG. 13 was already graphically indicated according to the amount, and the amount of the impedance was depicted in FIG. 14. In this context, it is only possible to detect insignificant deviations for large deflections. Therefore, for the loudspeaker in question, the behavior of the parameters is obtained as a function of each operating point, i.e., each deflection. It is necessary first to consider the behavior of stiffness k(x), as is depicted in FIG. 15. In each case, the estimated values (*) and a continuous approximation (solid line) are plotted for the estimated values, which are discussed in greater detail below.

The aforementioned asymmetry of the impedance curve is reflected here, which, however, can also be interpreted physically, because the resonance frequency is a function of the stiffness, if the oscillating mass is assumed to be constant. The minimum of stiffness, assuming positive deflections, is roughly 0.5 mm, whereas for negative deflections it rises sharply.

It is necessary next to look at the behavior of force factor Bl(x), as it is plotted in FIG. 16. The force factor has a light asymmetry toward the negative deflections, and otherwise falls away in both directions, which also corresponds to expectations, because there is the greatest flux density in the air gap, and it falls away at the edges. Overall, however, the relative change of the force factor for the deflections in question was not as pronounced as it was in the case of stiffness.

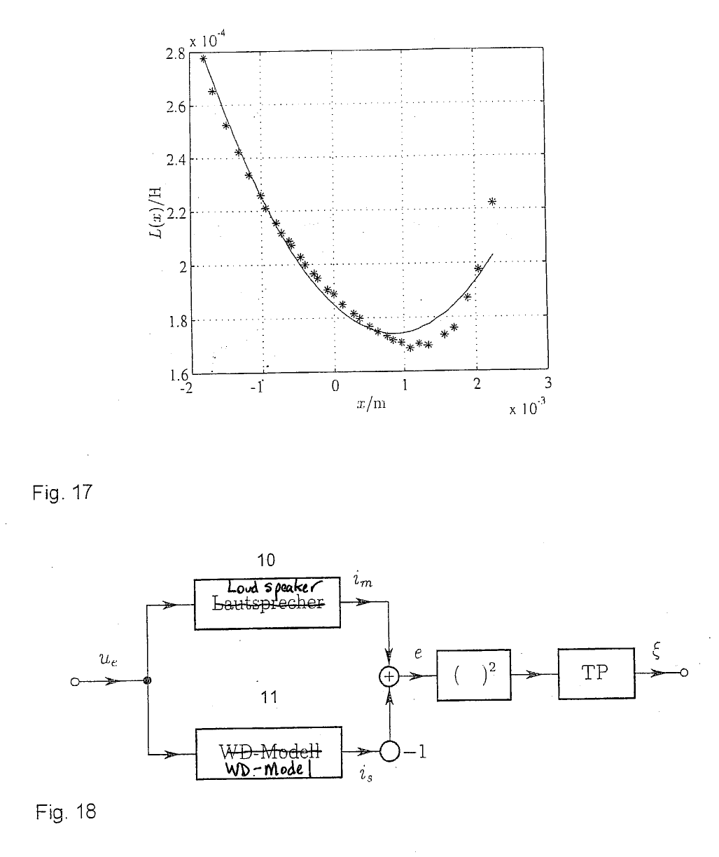

A somewhat weaker deflection dependency results for the moving-coil inductance, as can be seen from FIG. 17. Because only a limited frequency range was considered for determining the moving coil inductance, this value is greater by a factor of 2-3 than is the case in otherwise conventional measurements over a greater frequency range.

In order to be able to use the achieved results in the loudspeaker model, the deflection dependencies must be approximated using the functions of the location.

Heretofore, as is common in the literature, parabolic approximations have been used for this purpose, but for large deflections they describe the real behavior but poorly or even unfavorably. For example, the force factor could only be described for small deflections using a parabola that is open to the bottom, which had the effect that the parabola for large deflections could take on implausibly negative values. However, it actually seems physically meaningful that the force factor beginning from its maximum value for large deflections decreases at a slower and slower pace, i.e., approaches in an asymptotic manner the value of zero. Selected for this purpose as a possible function was

(49)

x_{Ob} representing a possible asymmetry and b_{O} representing the maximum value of force factor. For the moving-coil inductance, in addition to a parabola, a 3rd-order polynomial was also permitted. The reason for this lies in the physical motivation that the moving coil for the maximum negative deflection is situated entirely on the pole body and therefore takes on a maximum value. If then the coil moves in the direction of the position of rest and beyond that, then the self-inductance will at some point decrease to a potential minimum value, because the coil, up to the maximum positive deflection, always extends beyond the pole body. Therefore, as a possible approximation of this behavior

L(x)=l₀+l₁x+l₂x²+l₃x³ (50)

is permitted. However, the approximation l₃=0 is not sufficient. For the stiffness, a simple parabolic approximation is used

k(x)=k₀+k₁x+k₂x², (51)

because therefore the asymmetry and the progressive incline in response to an increasing deflection could be satisfactorily described. These deflection dependencies are plotted as function curves in FIGS. 15, 16, and 17, as continuous characteristic curves.

Adaptive Parameter Estimation

The deflection dependencies determined above function now as a starting value for the following adaptation method, i.e., the characteristic curves are implemented in the aforementioned WD model. If the model and the real loudspeaker are now supplied with the same input voltage uₑ, then due to a series resistance (in this case of 1 Ω) it is possible to measure actual moving-coil current iₘ and, by subtraction of the corresponding simulated current iₛ, to calculate an error signal

(52)

as it is depicted in FIG. 18. The goal of the adaptation is to adjust model 182 to real loudspeaker 181, so that it is necessary that the average squared error between the measured and the simulated moving-coil current is minimized. This adjustment is achieved as a result of the fact that the average squared error between measured current iₘ and current iₛ determined using simulation is minimized. According to experience, the condition of the loudspeaker (moving-coil current i, diaphragm deflection x, and diaphragm acceleration &&) and that of WD model 182 have approximately the same temporal curve, so that the condition of the loudspeaker can be estimated using the model. Therefore, in addition to a squaring operation, a deep-pass filtering (TP) of the error signal is carried out, so that it is possible using ξ(k) to obtain an estimated value for average squared error E{e²(k)}.

For the adaptation of the WD model, as an adaptation algorithm, the method of the steepest decrease is used, in accordance with which coefficient vector a to be adapted is changed in every time step in the direction of the negative gradient of the average squared error with respect to be coefficient vector, i.e., in accordance with the equation

α(k+1)−α(k)−diag(μ)∇. (53)

In this context, gradient ∇, which in turn represents a vector-worthy signal, is calculated as a partial derivation of average squared error ξ(k) in accordance with the coefficient vector via

$$∇ ( k ) - \frac{\partial ξ ( α , k )}{\partial α} . \qquad ( 54 )$$

The actual change of the coefficient can be influenced via the diagonal matrix diag(μ), so that it is possible for every coefficient αᵢ to indicate a separate step width μᵢ. It should be mentioned that it is not a question, in this context, of an LMS method, which uses actual error e(k) as the estimated value for the average squared error. Therefore, however, the error signal has a direct influence on the coefficient change, so that for assuring the convergence, a very small step width μᵢ must be selected. In the present case, the estimated average squared error acts upon the coefficient change so that the step width here can be adjusted for every coefficient for a more rapid convergence.

The Deep-Pass Filter

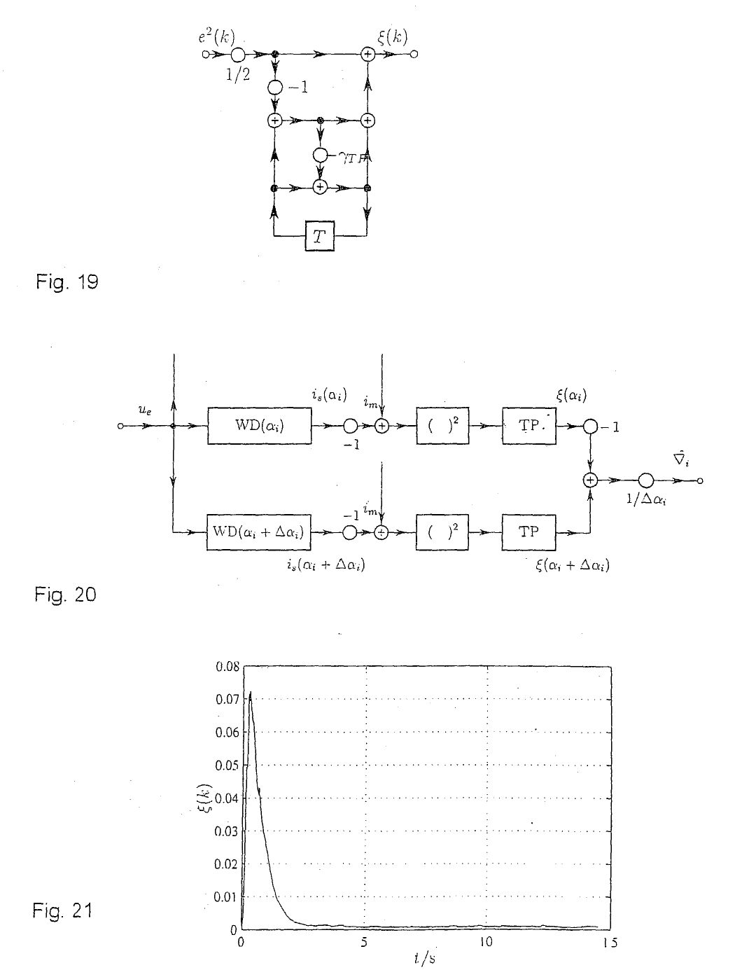

The deep-pass filter, in this context, supplies a cost-effective, sliding mean value generation, which renders superfluous the temporary storing and calculating of long data records. In this context, as a possible structure, a 1st-order bridge wave digital filter (FIG. 19) was selected, in which (3 dB-) cutoff frequency φ_{g}=tan(πf_{g}T) can be set via adapter coefficient γ_{TP} in accordance with the equation

$${γ}_{TP} = \frac{2 {ϕ}_{g}}{1 + {ϕ}_{g}} . \qquad ( 55 )$$

In response to a selection of f_{g}<1 Hz, it was possible in practice to achieve satisfactory results, because the error signal had the behavior of the input signal only to an insignificant degree.

The Gradient Filter

The calculation of an individual gradient

$${∇}_{i} = \frac{\partial ξ ( {α}_{i} )}{\partial {α}_{i}} \qquad ( 56 )$$

is approximated by calculating the differential quotient

$${∇}_{i} = \frac{ξ ( {α}_{i} + {Δα}_{i} ) - ξ ( {α}_{i} )}{{Δα}_{i}} . \qquad ( 57 )$$

The appropriate realization of the gradient determination is depicted in FIG. 20, input signal uₑ also being supplied to the loudspeaker as shown in FIG. 18, so that moving-coil current iₘ can be measured. Altogether, therefore, the original error signal calculation (FIG. 18) should be carried out twice for coefficient αᵢ to be adapted, once as a system having the nominal coefficients and once as a system in which only the observed coefficient is changed by Δαᵢ. If total gradient signal ∇(k) is therefore determined in every time cycle, then for N coefficients to be determined, (N+1) systems, composed of WD model, squaring procedure, and deep-pass filtering, must be implemented. However, this calculating expense, which initially seems high, can be advocated if a low scanning rate is used, because for measuring the system a colored noise signal, whose bandwidth is limited to a few hundred Hz, is preferably used.

Measuring Results

The success of the method presented is now documented on the basis of the loudspeaker measured here. As an input signal, a noise signal that is limited to the band range 20-500 Hz is used, onto which, in an additive fashion, a second noise signal in the frequency range 50-150 Hz is superimposed, so that the system in the range of the resonance frequency is powerfully excited. In this context, the signal level was selected so that the loudspeaker achieves deflections up to the limits of the permissible operating range. Using this roughly 15 s long signal, the loudspeaker was supplied with power, and the resulting moving-coil current and also the diaphragm deflection were measured for monitoring the adaptation results. Based on the starting values determined above, the adaptation was carried out, in which use was made of the possibility of setting an individual step width μᵢ for each coefficient. Coefficient vector α, in this context, contains all of the component values arising in the model, down to oscillating mass M, because the latter was determined many times (using different test masses) in a Thiele-Small parameter determination. From coupled differential equations (30, 31), however, it is also evident that not all the parameters can be determined at the same time, since especially equation (31) can be satisfied for different values of M. On the basis of error signal ξ(k) plotted in FIG. 21, the effect of the coefficient adaptation can be seen.

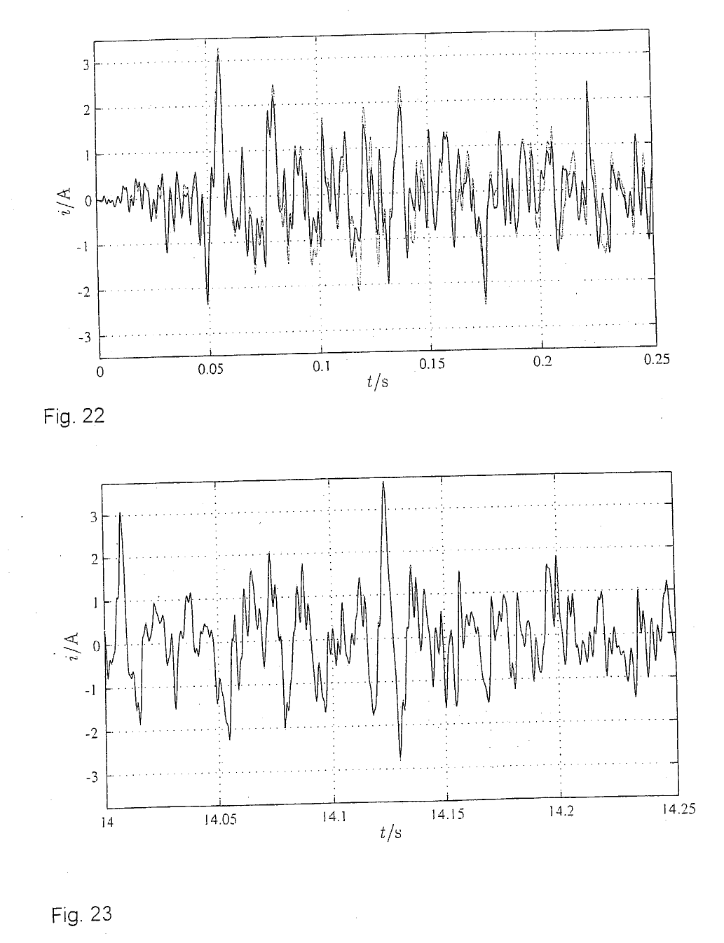

Error signal ξ(k) first rises in accordance with the cutoff frequency 0.5 Hz set in the deep-pass TP, so that effective coefficient changes are not brought about until a sufficient magnitude of the error signal, and a minimization of the error signal commences. After a few seconds, the error signal has therefore substantially faded away and, in this context, demonstrates the slow convergence behavior that is typical for the gradient method in the vicinity of the optimum. If measured moving-coil current iₘ and simulated moving-coil current iₛ are observed at the beginning (FIG. 22) and at the end (FIG. 23) of the adaptation, it is clear that measurement and simulation can scarcely be distinguished by the adaptation.

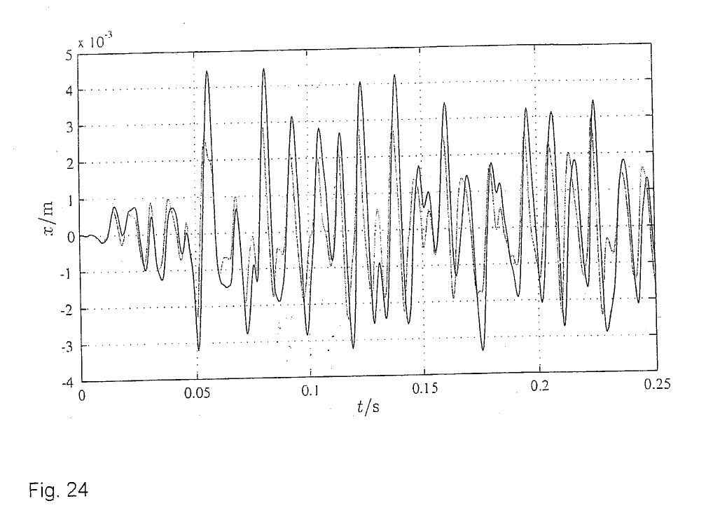

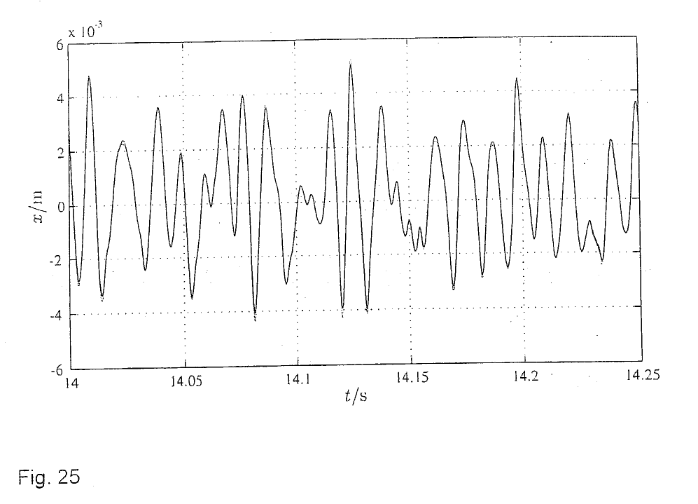

A similarly positive effect is achieved in observing the measured and simulated diaphragm deflection (FIGS. 24 and 25). I.e., although the error signal is derived on the “electrical” side, the identical improvement is achieved on the “mechanical” side. This is especially important because, using this simulation model, the system state of the loudspeaker (moving-coil current, diaphragm deflection, diaphragm acceleration) must be able to be reliably estimated for the subsequent compensation method.

In conclusion, it can therefore be asserted that a method was presented that makes it possible to determine the linear and nonlinear parameters of a loudspeaker model using an adaptation. For this purpose, a model was initially developed in the form of an equivalent electrical network, which takes into account the essential nonlinearities in the form of deflection- and current-controlled transformers. A time-discrete simulation of this passive network using so-called power waves provides a stable realization of the simulation model, in which the stability is not endangered even in adaptive operation. Use is made of this characteristic, in that an error signal is created from the measured and simulated moving-coil current, and subsequently, using a gradient method, the parameters of the loudspeaker model are adaptively changed so that the average squared error between these two currents is minimized. For the success of the gradient method, in this context, a determination of starting values is useful; otherwise, it would be necessary, using a different, possibly genetic, adaptation algorithm, to assure that a global minimum of the error function is striven for. Using the gradient method, a rapid convergence is certainly achieved, which is improved even more by the specific selection of the input signal. However, an adaptation based on the real music signal is also possible, and it presents itself in order to correct the operation-caused parameter changes (aging, temperature, installation) during operation. Therefore, overall a method is available which makes it possible to estimate the loudspeaker parameters in actual operation using a simple current measurement.

What is claimed is:

1. A method for determining loudspeaker parameters, comprising the following steps:
a) measuring the curves of the input voltage uₑ and of the moving-coil current iₘ of the loudspeaker;
b) calculating, using an electrical network model having variable parameters (α), a simulated moving-coil current iₛ associated with the measured input voltage uₑ;
c) adapting the variable parameters (α) of the network model to optimize a cost function that is derived from the model deviation e=iₘ−iₛ.

2. The method as recited in claim 1,
wherein the electrical network model contains a series circuit having the following elements:
a) a resistor (Rₑ);
b) a first transformer (uₛ₁), which is terminated on the secondary side by an inductor (Lₛ); and
c) a second transformer (uₛ₂), which, on the secondary side, contains the parallel circuit of a resistor (1/r), a capacitor (M), and a third transformer, the third transformer being terminated on the secondary side by an inductor (Lₖ).

3. The method as recited in one of claims 1 or 2,
wherein the network model is implemented in a time-discrete fashion, preferably by applying a wave digital realization to a continuous network model.

4. The method as recited in one of claims 1 through 3,
wherein a gradient method is used to adapt the variable parameters of the network model.

5. The method as recited in one of claims 1 through 4,
wherein, appropriate starting values for the parameters of the network model are determined by performing a pre-measurement of the loudspeaker.

6. The method as recited in one of claims 1 through 5,
wherein the cost function is derived from the squared model deviation e²=(iₘ−iₛ)², a temporal mean value generation and/or a deep-pass filtering being preferably being post-connected.
